(19) United States
(12) Patent Application Publication
(10) Pub. No.: US 2021/0114039 A1
(43) Pub. Date: Apr. 22, 2021

(54) PRELOAD TYPE GRANULATOR

(71) Applicant: SINO-ALLOY MACHINERY INC., Kuan-Yin estate (TW)

(72) Inventor: Mei-Chuan CHEN, Kuan-Yin estate (TW)

(21) Appl. No.: 17/138,467

(22) Filed: Dec. 30, 2020

Related U.S. Application Data
(63) Continuation-in-part of application No. 16/112,738, filed on Aug. 26, 2018.

(51) Int. Cl. B02C 18/18; F16D 3/06; B02C 18/24; B01J 2/20

(52) U.S. Cl. CPC B02C 18/18; F16D 3/06; B02C 2018/164; B01J 2/20; B02C 18/24

(57) ABSTRACT

A preload type granulator includes a drive unit, a transmission unit including a transmission sleeve rotatable by the drive unit and having displacement slots cut through the peripheral wall thereof, a first coil spring and a second coil spring with different spring coefficients connected in series and axially mounted in an installation space in the transmission sleeve, and a cutting unit including a connecting shaft fastened to the transmission sleeve by screw bolts respectively inserted through the displacement slots and threaded into the connecting shaft, a cutter holder mounted on the connecting shaft and a plurality of cutting tools mounted on cutter holder. Thus, the spring coefficient adjustment module is used to adjust the spring coefficients of the first coil spring and the second coil spring, so that the preload stroke of the cutting unit is adjusted to control the friction between the cutting tools and the die face.

### BACKGROUND OF THE INVENTION

### 1. Field of the Invention

The present invention relates to granulator technology and more particularly to a preload type granulator for cutting plastic into granules, which comprises a cutting unit, a drive unit, and a transmission unit coupled between the cutting unit and the drive unit and provided with a series of coil springs with different spring coefficients that generates a constant spring pressure to adjust the pressure between the cutting unit and the die surface, controlling the friction between the cutting unit and the die surface and improving the service life of the cutting tools.

### 2. Description of the Related Art

Most granulators are used to make plastic granules. These granulators commonly use a motor to rotate cutting tools, and the cutting tools are pressed against the die face. When the material is extruded by the die face, the cutting tools cut the material into granules.

In order to slow the wear rate of the cutting tools and the die face, a sliding device is provided between the cutting tools and the drove unit to control the position of the cutting tools so that the relative position between the cutting tools and the die face can be controlled. However, the movement of the sliding device is controlled by an electronic instrument, which is relatively large in volume, requires a large installation space, and has a high installation cost.

### SUMMARY OF THE INVENTION

The present invention has been accomplished under the circumstances in view. It is therefore the main object of the present invention to provide a preload type granulator, which uses a pure mechanical structure to control the pressure between the die face and the cutting unit, thereby controlling the friction between the cutting unit and the die face.

To achieve this and other objects of the present invention, a preload type granulator comprises a drive unit, a transmission unit, a spring coefficient adjustment module, and a cutting unit. The drive unit comprising a motor, and a motor shaft rotatable by the moto. The transmission unit comprises a transmission sleeve, a first shaft, a second shaft, a first coil spring and a second coil spring. The first coil spring and the second coil spring have different spring coefficient. The transmission sleeve is mounted on the motor shaft, comprising an installation space extending along the axis thereof. The installation space comprises a first preload space and a second preload space. The diameter of the first preload space is greater than the diameter of the second preload space. The first coil spring is sleeved onto the first shaft. The second coil spring is sleeved onto the second shaft. The second shaft comprises a slot extending along the axis thereof. The slot of the second shaft is attached onto a bottom end of the first shaft so that the first shaft is axially movable in the slot of the second shaft. The first coil spring and the second coil spring are connected in series and mounted in the installation space. The first coil spring is set in the first preload space. The second coil spring is set in the second preload space and protrudes from the second preload space into the first preload space. The second shaft is axially movable along the axis of the second coil spring toward or away from a bottom end of the second preload space. The first shaft is axially movable along the axis of the slot of the second shaft toward or away from a bottom end of the second preload space. The transmission sleeve comprises a plurality of displacement slots cut through the surface thereof. The spring coefficient adjustment module comprises a first spring coefficient adjustment unit and a second spring coefficient adjustment unit. The first spring coefficient adjustment unit and the second spring coefficient adjustment unit are used to adjust the spring coefficients of the first coil spring and the second coil spring respectively. The first spring coefficient adjustment unit is mounted on the first shaft to correspond to the first coil spring. The second spring coefficient adjustment unit is mounted on the second shaft to correspond to the second coil spring. The first spring coefficient adjustment unit and the second spring coefficient adjustment unit are used to change the preload lengths of the first coil spring and the second coil spring respectively so as to adjust the spring coefficients of the first coil spring and the second coil spring respectively. The cutting unit comprises a cutter holder, a connecting shaft, and a plurality of cutting tools. The cutting tools are mounted in the cutter holder. The connecting shaft is mounted in the center of the cutter holder and fastened to the transmission sleeve by screw bolts that are respectively inserted through the displacement slots and threaded into the connecting shaft. The connecting shaft has a bottom end surface thereof connected to the first shaft. The preload stroke of the cutting unit is adjustable by the first coil spring and the second coil spring.

Thus, the spring coefficients of the first coil spring and the second coil spring are used to adjust the pressure and distance between the cutting unit and the die face, and the relative positioning between the screw bolts and the displacement slots is used to adjust the displacement stroke of the cutting unit. Thus, the cutting unit can produce different constant pressure on the die face according to different granulation requirements for different materials.

When the preload type granulator is used to cut plastic into granules, the die face is moved toward the cutting unit, When the cutting tools of the cutting unit touch the die face, the cutting tools are displaced toward the preload stroke. Thus, the spring coefficients of the first coil spring and the second coil spring adjust the relative distance between the cutting tools and the die face, thereby controlling the friction between the cutting tools and the die face. This improves the life of the cutting tools, controls the loss of the die face, and reduces the contamination of the metal material. Since the first coil spring and the second coil spring mechanically control the distance between the cutting unit and the die face, no mechanical operations are required.

### BRIEF DESCRIPTION OF THE DRAWINGS

FIG. 1 is an oblique top elevational view of a preload type granulator in accordance with the present invention.

FIG. 2 is a schematic applied view of the preload type granulator in accordance with the present invention.

FIG. 3 is a longitudinal sectional view of the preload type granulator in accordance with the present invention.

FIG. 4 is an enlarged view of a part of the present invention, illustrating the configuration of the transmission unit.

FIG. 5 is an enlarged view of a part of FIG. 3.

FIG. 6 is an exploded view of the preload type granulator in accordance with the present invention FIG. 7 illustrates the status of the spring coefficient adjustment module before use.

FIG. 8 illustrates the status of the first spring coefficient adjustment unit before use.

FIG. 9 illustrates the status of the second spring coefficient adjustment unit before use.

FIG. 10 is a sectional view of the cutting chamber.

### DETAILED DESCRIPTION OF THE PREFERRED EMBODIMENT

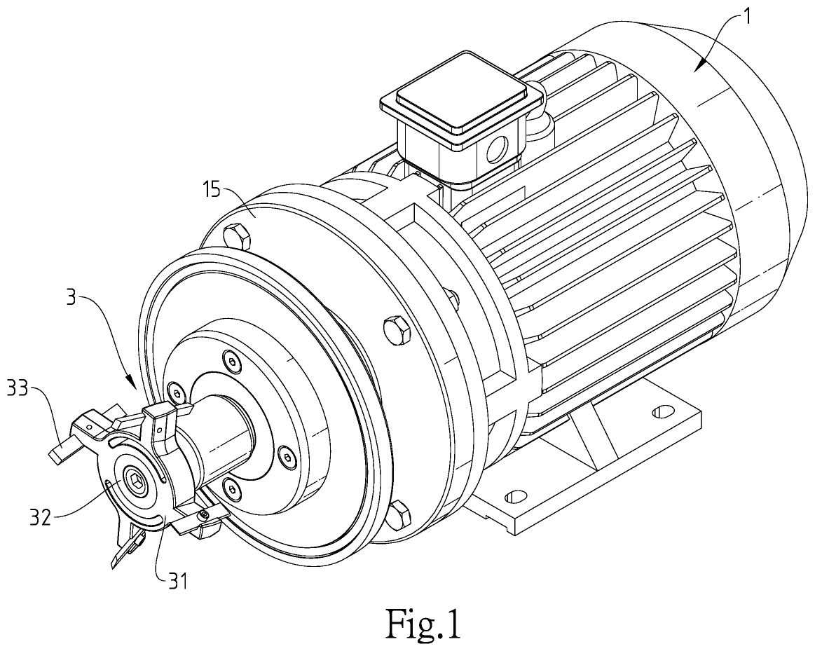

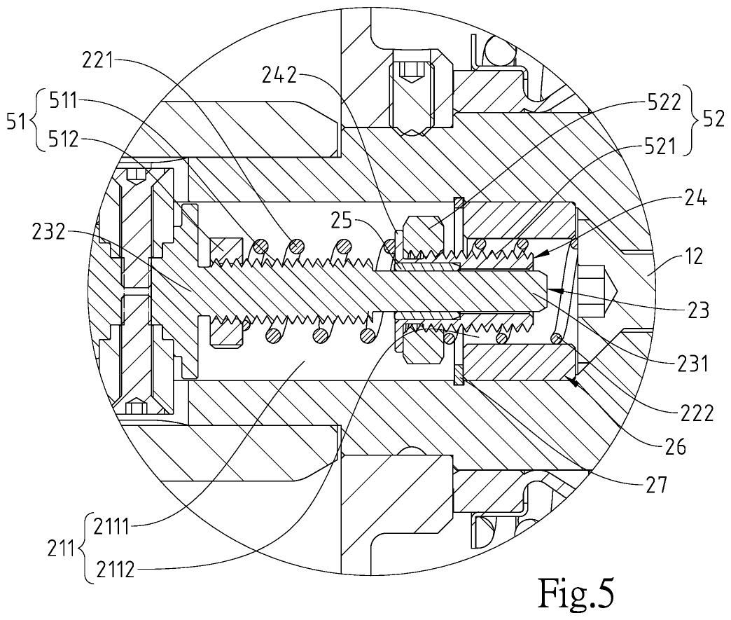

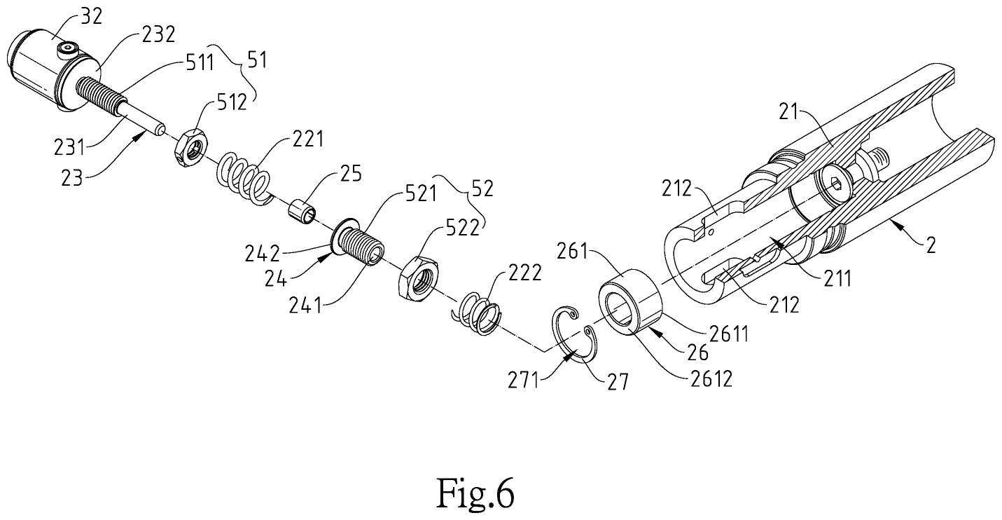

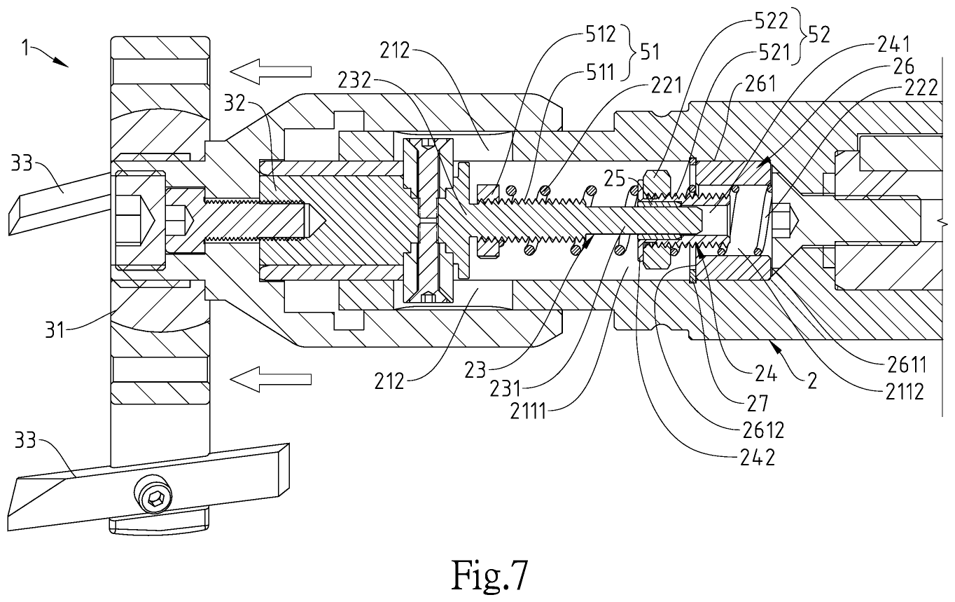

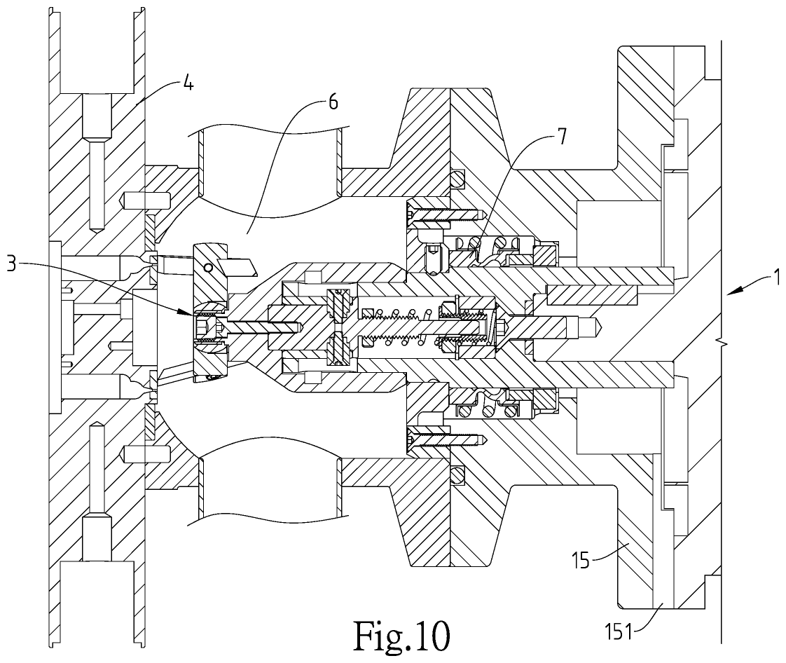

Referring to FIGS. 1-10, a preload type granulator in accordance with the present invention is shown. The preload type granulator comprises a drive unit (1), a transmission unit (2), a cutting unit (3), and a spring coefficient adjustment module (5).

The drive unit (1) comprises a motor (11), and a motor shaft (12) driven to rotate by the motor (11). The motor shaft (12) comprises a locating groove (13), and a drive key (14) that sits partly into the locating groove (13) and partly into the transmission unit (2) so that the drive unit (1) can drive the transmission unit (2).

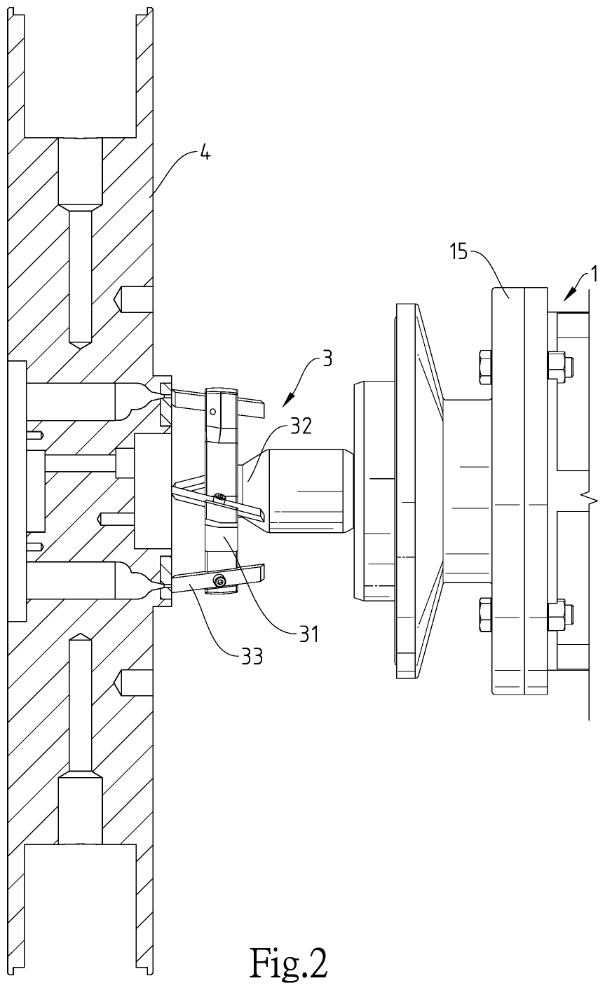

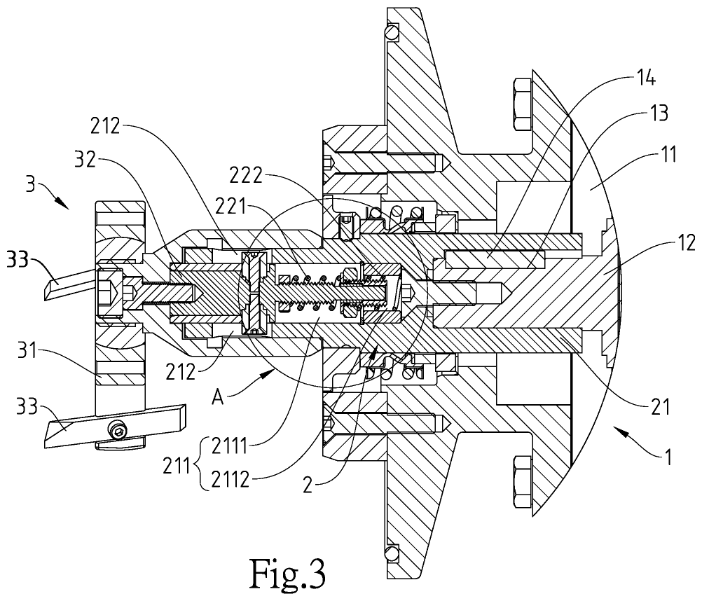

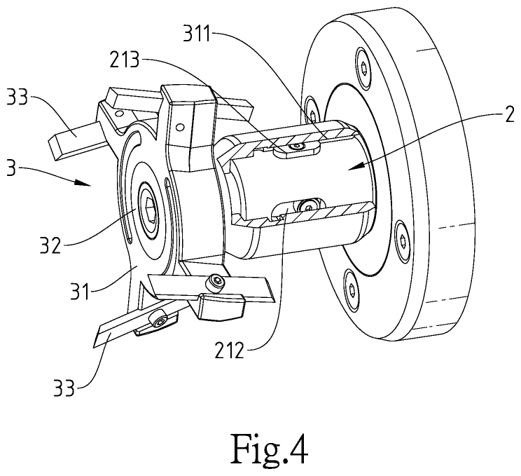

The transmission unit (2) comprises a transmission sleeve (21), a first shaft (23), a second shaft (24), a first coil spring (221) and a second coil spring (222). The first coil spring (221) and a second coil spring (222) have different spring coefficients. In the present preferred embodiment, the first coil spring (221) is a high-elasticity coil spring, and the second coil spring (222) is a low-elasticity coil spring, i.e., the spring coefficient of the first coil spring (221) is larger than the spring coefficient of the second coil spring (222). The transmission sleeve (21) is mounted on the motor shaft (12). More specifically, as illustrated in FIG. 3, the transmission sleeve (21) is axially coupled to the motor shaft (12) by a coupling bolt. In addition, the transmission sleeve (21) is provided with an installation space (211) along the axial direction. The installation space (211) comprises a first preload space (2111) and a second preload space (2112). The pipe diameter of the first preload space (2111) is greater than the pipe diameter of the second preload space (2112). The first coil spring (221) is sleeved onto the first shaft (23). The second coil spring (222) is sleeved onto the second shaft (24). The second shaft (24) has a slot (241) along the axis. The slot (241) of the second shaft (24) is attached onto a bottom end of the first shaft (23) so that the first shaft (23) can be moved axially in the slot (241). The first coil spring (221) and the second coil spring (222) are connected in series and then set in the installation space (211). The first coil spring (221) is set in the first preload space (2111). The second coil spring (222) is set in the second preload space (2112) and protruded from the second preload space (2112) into the first preload space (2111). The pipe diameter of the second preload space (2112) is slightly greater than the outer diameter of the second coil spring (222). The shape of the second preload space (2112) corresponds to the shape of the second coil spring (222). The protruding length of the second coil spring (222) into the first preload space (2111) is smaller than the length of the part of the second coil spring (222) in the second preload space (2112). In this way, the second coil spring (222) can be positively positioned in the second preload space (2112). The second shaft (24) is movable along the axis of the second coil spring (222) toward or away from the bottom end of the second preload space (2112). The first shaft (23) is axially movable along the slot (241) of the second shaft (24) toward or away from the bottom end of the second preload space (2112). As shown in FIGS. 7-9, the first coil spring (221) and the second coil spring (222) are springs of different diameters connected to each other. Further, the transmission sleeve (21) has a plurality of displacement slots (212) cut through the peripheral wall thereof. As illustrated in FIGS. 2 and 4, the displacement slots (212) are arranged on opposing top and bottom sides of the transmission sleeve (21) (the left and right sides in FIG. 4). Further, in order to prevent deflection during rotation, the surface of the transmission sleeve (21) is further provided with a plurality of transmission keys (213) for driving the cutting unit (3) to rotate synchronously.

The spring coefficient adjustment module (5) comprises a first spring coefficient adjustment unit (51) and a second spring coefficient adjustment unit (52). The first spring coefficient adjustment unit (51) is mounted on the first shaft (23) corresponding to the first coil spring (221). The second spring coefficient adjustment unit (52) is mounted on the second shaft (24) corresponding to the second coil spring (222). The first spring coefficient adjustment unit (51) and the second spring coefficient adjustment unit (52) are used to change the preload length of the first coil spring (221) and the second coil spring (222) respectively, thereby adjusting spring coefficient of the first coil spring (221) and the second coil spring (222) respectively.

The transmission unit (2) further comprises a bushing (26) and a fixing member (27). The bushing (26) is mounted in the bottom end of the installation space (211) of the transmission sleeve (21). The fixing member (27), for example, C-shaped retaining ring, fixes the bushing (26) in the installation space (211). The second preload space (2112) is defined in the installation space (211) through the setting of the bushing (26). Therefore, the annular body (261) of the bushing (26) surrounds the second preload space (2112), and both ends of the annular body (261) have a bottom end surface (2611) and a top end surface (2612) respectively. The second preload space (2112) communicates with the bottom end surface (2611) and the top end surface (2612). The outer peripheral surface of the annular body (261) abuts against the inner wall of the installation space (211). The bottom end surface (2611) abuts against the bottom end of the installation space (211). The top end surface (2612) is supported by the second spring coefficient adjustment unit (52). The second preload space (2112) accommodates the second coil spring (222). The shape of the second preload space (2112) surrounded by the bushing (26) corresponds to the shape of the second coil spring (222). The inner diameter of the second preload space (2112) is slightly greater than the outer diameter of the second coil spring (222). This can effectively prevent the deviation of the second coil spring (222). The fixing member (27) has an opening (271) facing the second preload space (2112) for the passing of the second coil spring (222).

The second spring coefficient adjustment unit (52) comprises a second thread (521) and a second nut (522). The second thread (521) is formed on the second shaft (24). The second nut (522) can be threaded onto the second thread (521) and displaced along the length of the second shaft (24). The second shaft (24) comprises a flange (242). The bottom end of the second shaft (24) is inserted into the second preload space (2112) of the bushing (26) and located in the inner diameter space of the second coil spring (222). The flange (242) is located outside the bushing (26). The second nut (522) is movable between the flange (242) and the top end surface (2612) of the bushing (26). The second coil spring (222) is located between the second nut (24) and the bottom end of the second preload space (2112) with the two opposite ends thereof respectively abutted against the second nut (24) and the bottom end of the second preload space (2112).

The first spring coefficient adjustment unit (51) comprises a first thread (511) and a first nut (512). The first thread (511) is formed on the first shaft (23). The first nut (512) is threaded onto the first thread (511) and can be displaced along the length of the first shaft (23). The first shaft (23) comprises a shaft body (231) and a connecting portion (232). The shaft body (231) is inserted into the slot (241) of the second shaft (24), so that the shaft body (231) is axially movable in the slot (241). In order to reduce the friction and wear when the shaft body (231) moves axially in the slot (241), a shaft sleeve (25) can be sleeved on the shaft body (231), and then the shaft sleeve (25) and the shaft body (231) are inserted into the slot (241) together. The connecting portion (232) is used to connect the first shaft (23) to the connecting shaft (32) of the cutting unit (3). In this embodiment, the connecting portion (232) is integrally formed with the connecting shaft (32). However, this is not a limitation. Alternatively, the connecting portion (232) can also be fixed on the connecting shaft (32) is a joint manner. The first nut (512) is movable between the bottom surface of the connecting shaft (32) and the flange (242) of the second shaft (24). The first coil spring is located between the first nut (512) and the flange (242) with the two opposite ends respectively abutted against the first nut (512) and the flange (242).

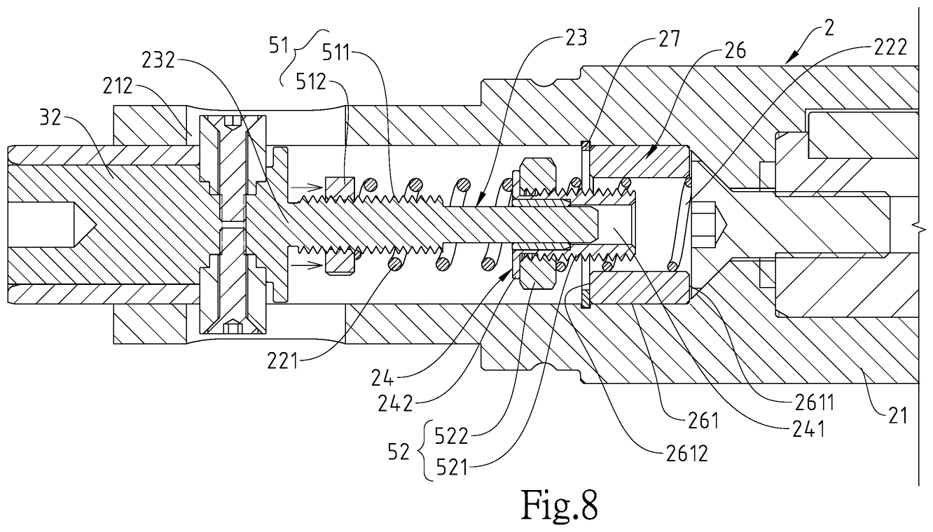

Referring to FIG. 8, when you want to adjust the spring coefficient of the first coil spring (221), move the first nut (512) along the first thread (511) of the first shaft (23) toward the bottom end of the second preload space (2112) to shorten the preload length of the first coil spring (221), thereby increasing the spring coefficient of the first coil spring (221). Conversely, the first nut (512) can also be displaced along the first thread (511) toward the cutting unit (3), so that the preload length of the first coil spring (221) becomes larger, thereby reducing the spring coefficient of the first coil spring (221).

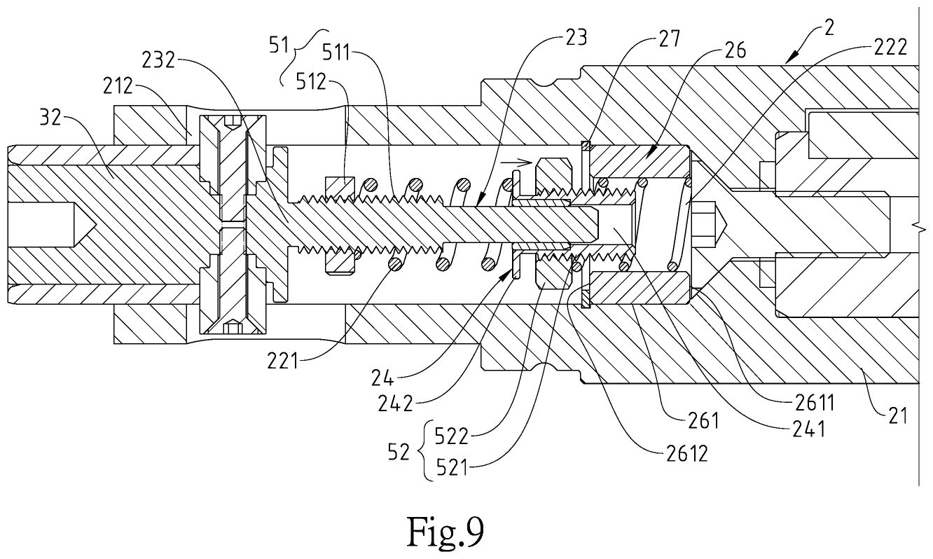

Referring to FIG. 9, when you want to adjust the spring coefficient of the second coil spring (222), move the second nut (522) along the second thread (521) of the second shaft (24) toward the bottom end of the second preload space (2112) to shorten the preload length of the second coil spring (222), thereby increasing the spring coefficient of the second coil spring (222). Conversely, the second nut (522) can also be displaced along the second thread (521) toward the cutting unit (3), so that the preload length of the second coil spring (222) becomes larger, thereby reducing the spring coefficient of the second coil spring (222).

The cutting unit (3) comprises a cutter holder (31), a connecting shaft (32) and a plurality of cutting tools (33). These cutting tools (33) are mounted in the cutter holder (31). The connecting shaft (32) is mounted in the center of the cutter holder (31). Screw bolts (not shown) are respectively inserted through the displacement slots (212) and threaded into the connecting shaft (32) to fasten the connecting shaft (32) to the transmission sleeve (21). The bottom end surface of the connecting shaft (32) is connected to the first shaft (23). The preload stroke of the cutting unit (3) is adjusted by the first coil spring (221) and the second coil spring (222). The spring coefficients of the first coil spring (221) and the second coil spring are adjusted by the spring coefficient adjustment module (5).

Further, the cutter holder (31) has a plurality of transmission key grooves (311) located on an inside wall thereof corresponding to the transmission keys (213). After the cutter holder (31) is coupled to the transmission sleeve (21), the cutter holder (31) can be driven by the transmission sleeve (21) to rotate the cutting tools (33).

It is understandable that bushing (26) can also be set in the installation space (211) in an integrated manner, and the setting of the fixing member (27) can be omitted at this time. The spring coefficient of the second coil spring (222) in the second preload space (2112) within the bushing (26) is smaller than the spring coefficient of the first coil spring (221). Therefore, when the cutting tools (33) of the cutting unit (3) move toward the preload stroke after touched the die face (4), the second coil spring (222) will be compressed and elastically deformed first, and then the first coil spring (221) will deform with elastic compression. In order to prevent the adverse effects caused by the possible offset of the second coil spring (222) when the second coil spring (222) is compressed and elastically deformed, the second coil spring (222) is limited to the second preload space (2112) of the bushing (26), and the inner diameter of the bushing (26) is configured to be slightly larger than the outer diameter of the second coil spring (222).

In addition, when the bushing (26) is set at the bottom end of the installation space (211) of the transmission sleeve (21), the outer peripheral surface of the annular body (261) abuts against the inner wall of the installation space (211), and its bottom end surface (2611) abuts against the bottom end of the installation space (211) of the transmission sleeve (21), and its top end surface (262) abuts against the fixing member (27).

In this way, the bushing (26) is limited between the fixing member (27) and the bottom end of the installation space (211) without moving. Furthermore, the aperture of the second preload space (2112) is smaller than that of the opening (271) of the fixing member (27), and the size of the second nut (522) of the second spring coefficient adjustment unit (52) is smaller than the aperture of the opening (271) of the fixing member (27) and larger than the aperture of second preload space (2112). In this way, when the cutting tools (33) on the cutting unit (3) contact the die face (4) and move toward the preload stroke, the spring coefficients of the first coil spring (221) and the second coil spring (222) can be used to adjust the relative distance between the cutting tools (33) and the die face (4), so that the second nut (522) of the second spring coefficient adjustment unit (52) can abut against the top end surface (2612) of bushing (26) but not against the fixing member (27). Therefore, bushing (26) has the function of preventing the deviation of the second coil spring (222) as mentioned above, and also has a function for the second nut (522) of the second spring coefficient adjustment unit (52) to abut. It can prevent the first coil spring (221) from continuing to compress the second coil spring (222) and cause the second coil spring (222) to be excessively fatigued or damaged, so it has the function of protecting the second coil spring (222).

It is worth mentioning that due to the rotation of the transmission sleeve (21), the spring coefficient adjustment module (5), first coil spring (221), second coil spring (222), bushing (26) and fixing member (27) set in the installation space (211) of the transmission sleeve (21) must ensure that they will not be affected by the centrifugal force during rotation and cause their own efficiency to deteriorate. Therefore, in this embodiment, the inner diameter of the first coil spring (221) is slightly larger than the outer diameter of the first thread (511) located on the first shaft (23), and the difference between the two is usually smaller than the pitch of the first coil spring (221). Similarly, the inner diameter of the second coil spring (222) is slightly larger than the outer diameter of the second thread (521) located on the second shaft (24), and the difference between the two is usually smaller than the pitch of the second coil spring (222). The inner diameter of the bushing (26) is slightly larger than the outer diameter of the second coil spring (222). Such a design can effectively reduce the adverse effects of centrifugal force on the first coil spring (221) and the second coil spring (222) during rotation.

In addition, the outer diameters of the first coil spring (221) and the second coil spring (222) are substantially the same, and the axes of the two are substantially located on the same axis. Therefore, when the first coil spring (221) and the second coil spring (222) are connected in series, the force application points of both can be located in the same straight line, which can prevent the first coil spring (221) and the second coil spring (222) from shifting during elastic compression and deformation.

Referring to FIGS. 1-10 again, the manner of use of the present invention and the advantages the present invention can achieve are as follows:

1. The operator selects the corresponding first coil spring (221) and second coil spring (222) according to the material characteristics of the die face (4), such as springs with different wire diameters, springs with different diameters, springs of different materials and different lengths, and then connects the first coil spring (221) and the second coil spring (222) in series and mounts the series of elastic modules (22) in the mounting portion (211) of the transmission sleeve (21), and then mounts the connecting shaft (32) axially in the transmission sleeve (21), and then mounts respective screw bolts through the displacement slots (212) to adjust the preload stroke of the connecting shaft (32), and then mounts the cutting tools (33) in the cutter holder (31) and mounts the cutter holder (31) and the connecting shaft (32) together.

2. When the preload type granulator is used to cut plastic into granules, move the die face (4) toward the cutting unit (3), When the cutting tools (33) of the cutting unit (3) touch the die face (4), the cutting tools (33) are displaced toward the preload stroke. The elastic coefficients of the first coil spring (221) and the second coil spring (222) adjust the relative distance between the cutting tools (33) and the die face (4), thereby controlling the friction between the cutting tools (33) and the die face (4) (that is, cutting with the smallest contact surface). This improves the life of the cutting tools (33), controls the loss of the die face (4), and reduces the contamination of the metal material. Since the first coil spring (221) and the second coil spring (222) mechanically control the distance between the cutting unit (3) and the die face (4), no mechanical operations are required. When the tool consumption of the cutting tools (33) reaches 10 mm, it means that the service life of the cutting tools (33) has expired, and new cutting tools (33) must be replaced at this time. Before the tool consumption of the cutting tools (33) reaches 10 mm, the tool consumption produced by the cutting tools (33) will affect the friction force between the cutting tools (33) and the die face (4). At this time, it is necessary to rely on the elastic deformation and elastic force of the first coil spring (221) and the second coil spring (222) to compensate for the tool consumption of the cutting tools (33) to ensure that the cutting tools (33) can continuously and stably contact the die face (4) to generate constant friction, thereby providing better cutting results.

3. When the cutting tools (33) on the cutting unit (3) contact the die face (4), the elastic coefficients of the first coil spring (221) and the second coil spring (222) can be used to adjust the relative distance between the cutting tools (33) and die face (4), and then control the friction between the cutting tools (33) and the die face (4). Through the change of friction between the cutting tools (33) and the die face (4) during cutting, the wear of the cutting tools (33) can be known. The spring coefficient adjustment module (5) is used to change the preload length of the first coil spring (221) and the second coil spring (222), so as to adjust the spring coefficients of the first coil spring (221) and the second coil spring (222).

4. When the cutting unit (3) runs in the cutting chamber (6) to produce plastic pellets, water is used to cool the cutting tools (33). Since the transmission unit (2) is provided with a waterproof sealing structure (7), it can prevent water from moving from the cutting chamber (6) to the drive unit (1). In addition, a drain (151) is provided on the flange (15) of the drive unit (1), so that when water flows out from the drain (151), it can be known that the waterproof sealing structure (7) has been damaged and needs to be replace with a new one.

What the invention claimed is:

1. A preload type granulator, comprising:
a drive unit comprising a motor and a motor shaft rotatable by said motor;
a transmission unit comprising a transmission sleeve, a first shaft, a second shaft, a first coil spring and a second coil spring, said first coil spring and said second coil spring having different spring coefficients, said transmission sleeve being mounted on said motor shaft, said transmission sleeve comprising an installation space extending along the axis thereof, said installation space comprising a first preload space and a second preload space, the diameter of said first preload space being greater than the diameter of said second preload space, said first coil spring being sleeved onto said first shaft, said second coil spring being sleeved onto said second shaft, said second shaft comprising a slot extending along the axis thereof, said slot of said second shaft being attached onto a bottom end of said first shaft so that said first shaft is axially movable in said slot of said second shaft, said first coil spring and said second coil spring being connected in series and mounted in said installation space, said first coil spring being set in said first preload space, said second coil spring being set in said second preload space and protruding from said second preload space into said first preload space, said second shaft being axially movable along the axis of said second coil spring toward or away from a bottom end of said second preload space, said first shaft being axially movable along the axis of said slot of said second shaft toward or away from a bottom end of said second preload space, said transmission sleeve comprising a plurality of displacement slots cut through the surface thereof;
a spring coefficient adjustment module comprising a first spring coefficient adjustment unit and a second spring coefficient adjustment unit, said first spring coefficient adjustment unit and said second spring coefficient adjustment unit being used to adjust the spring coefficients of said first coil spring and said second coil spring respectively, said first spring coefficient adjustment unit being mounted on said first shaft to correspond to said first coil spring, said second spring coefficient adjustment unit being mounted on said second shaft to correspond to said second coil spring, said first spring coefficient adjustment unit and said second spring coefficient adjustment unit being used to change the preload lengths of said first coil spring and said second coil spring respectively so as to adjust the spring coefficients of said first coil spring and said second coil spring respectively; and
a cutting unit comprising a cutter holder, a connecting shaft and a plurality of cutting tools, said cutting tools being mounted in said cutter holder, said connecting shaft being mounted in the center of said cutter holder, said connecting shaft being fastened to said transmission sleeve by screw bolts that are respectively inserted through said displacement slots and threaded into said connecting shaft, said connecting shaft having a bottom end surface thereof connected to said first shaft, the preload stroke of said cutting unit being adjustable by said first coil spring and said second coil spring.

2. The preload type granulator as claimed in claim 1, wherein the spring coefficient of said first coil spring is greater than the spring coefficient of said second coil spring.

3. The preload type granulator as claimed in claim 1, wherein the length of the part of said second coil spring protruding into said first preload space is shorter than the length of the part of said second coil spring located in said second preload space.

4. The preload type granulator as claimed in claim 1, wherein the pipe diameter of said second preload space is larger than the outer diameter of said second coil spring.

5. The preload type granulator as claimed in claim 1, wherein the shape of said second preload space corresponds to the shape of said second coil spring.

6. The preload type granulator as claimed in claim 1, wherein said transmission unit further comprises a bushing mounted in a bottom end of said installation space of said transmission sleeve.

7. The preload type granulator as claimed in claim 1, wherein said second spring coefficient adjustment unit comprises a second thread and a second nut, said second thread being formed on said second shaft, said second nut being threaded onto said second thread and movable along the length of said second shaft; said second coil spring has two opposite ends thereof respectively abutted against said second nut and the bottom end of said second preload space.

8. The preload type granulator as claimed in claim 1, wherein said first spring coefficient adjustment unit comprises a first thread and a first nut, said first thread being formed on said first shaft, said first nut being threaded onto said first thread and movable along the length of said first shaft; said first coil spring has two opposite ends thereof respectively abutted against said first nut and said second shaft.

9. The preload type granulator as claimed in claim 1, wherein the inner diameter of said first coil spring is greater than the outer diameter of said first thread located on said first shaft.

10. The preload type granulator as claimed in claim 1, wherein the difference between the inner diameter of said first coil spring and the outer diameter of said first thread is smaller than the pitch of said first coil spring.

11. The preload type granulator as claimed in claim 1, wherein the inner diameter of said second coil spring is greater than the outer diameter of said second thread located on said second shaft.

12. The preload type granulator as claimed in claim 1, wherein the difference between the inner diameter of said second coil spring and the outer diameter of said second thread is smaller than the pitch of said second coil spring.

13. The preload type granulator as claimed in claim 1, wherein the outer diameter of said first coil spring and the outer diameter of said second coil spring are approximately the same, and the axis of said first coil spring and the axis of said second coil spring are approximately on the same axis.

14. The preload type granulator as claimed in claim 1, wherein said motor shaft further comprises a locating groove, and a drive key set in said locating groove for driving said transmission unit to rotate.

15. The preload type granulator as claimed in claim 1, wherein said transmission sleeve comprises a plurality of transmission keys for driving said cutting unit to rotate synchronously; said cutter holder comprises a plurality of transmission key grooves located on an inside wall thereof and respectively coupled to said transmission keys for enabling said cutter holder to be rotated by said transmission sleeve.
